(19) United States
(12) Patent Application Publication
(10) Pub. No.: US 2026/0196166 A1
(43) Pub. Date: Jul. 9, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Jungmin KU, Suwon-si (KR); Sunghwan JANG, Suwon-si (KR); Seoyoung KIM, Suwon-si (KR)

(73) Assignee: SAMSUNG ELECTRONICS CO., LTD., Suwon-si (KR)

(21) Appl. No.: 19/443,812

(22) Filed: Jan. 8, 2026

Related U.S. Application Data
(63) Continuation of application No. PCT/KR2025/022923, filed on Dec. 26, 2025.

(30) Foreign Application Priority Data
Jan. 8, 2025 (KR) 10-2025-0003069

(51) Int. Cl. G09G 3/3208; G09G 3/28; G09G 3/32

(52) U.S. Cl. CPC G09G 3/3208; G09G 3/28; G09G 3/32; G09G 2320/0247; G09G 2320/103; G09G 2360/144; G09G 2360/16

(57) ABSTRACT

An electronic apparatus may control the display to display image content, acquire information on an average picture level (APL) value representing average brightness of pixels of image frames included in the image content, identify based on the information on the APL value, whether a first scene including first image frames having a first APL value that is less than a preset threshold value transitions to a second scene including second image frames. The second image frames having a second APL value that is greater than or equal to the preset threshold value, adjust a current scaling ratio for the second scene such that a second current scaling ratio that is lower than a first current scaling ratio corresponding to the second APL value increases to the first current scaling ratio, and control the display to display the second image frames included in the second scene.

### CROSS-REFERENCE TO RELATED APPLICATION

This application is a continuation application is a continuation application, under 35 U.S.C. § 111(a), of international application No. PCT/KR2025/022923, filed Dec. 26, 2025, which claims priority under 35 U.S.C. § 119 to Korean Patent Application No. 10-2025-0003069, filed Jan. 8, 2025, the disclosures of which are incorporated herein by reference in their entireties.

### TECHNICAL FIELD

Apparatuses and methods consistent with the disclosure relate to an electronic apparatus and a controlling method of an electronic apparatus, and more particularly, to an electronic apparatus capable of preventing user glare and a controlling method of an electronic apparatus.

### BACKGROUND ART

Recently, with the advent of the content era, display-related technologies have been advancing. In particular, recently, technologies related to self-emissive displays, such as an organic light emitting diode (OLED) and a micro light emitting diode (micro LED), have been advancing.

When using the self-emissive displays, a current scaling ratio may be adjusted to improve maximum brightness and maintain stable power consumption when only some of all pixels are turned on. However, because the current scaling ratio may not be set to infinity, conventional technologies have a fixed current scaling ratio at a specific average picture level (APL) or less.

Therefore, according to the prior art, when a scene transitions from a dark scene with an average picture level (APL) less than or equal to a specific APL to a bright scene with an APL exceeding the specific APL while image content is displayed, the amount of light corresponding to the APL and the current scaling ratio corresponding thereto rapidly changes, resulting in an issue where users viewing the image content experience glare.

### DISCLOSURE OF INVENTION

### Solution to Problem

The present disclosure addresses the problems of the prior art described above, and provides an electronic apparatus capable of preventing user glare even when brightness of image content changes rapidly, and a controlling method thereof.

In accordance with an aspect of the disclosure, an electronic apparatus includes: a display; a memory configured to store at least one instruction; and a processor configured to execute the at least one instruction, in which the processor may be configured to control the display to display image content, acquire information on an average picture level (APL) value representing average brightness of pixels of image frames included in the image content, identify based on the information on the APL value, whether a first scene including first image frames, among the image frames, having a first APL value less than a preset threshold value transitions to a second scene including second image frames, among the image frames, while the image content is displayed on the display, the second image frames having a second APL value that is greater than or equal to the threshold value, adjust, based on the first scene being identified as transitioning to the second scene, a current scaling ratio for the second scene while the second scene is displayed on the display, the current scaling ratio being adjusted such that the second scene increases from a second current scaling ratio that is lower than a first current scaling ratio corresponding to the second APL value to the first current scaling ratio, and control the display to display the second image frames included in the second scene based on the adjusted current scaling ratio for the second scene.

The memory may store information on the current scaling ratio to drive the display according to the APL value, and the information on the current scaling ratio may include information preset to have the current scaling ratio fixed at less than or equal to the preset threshold value.

The processor may be configured to identify whether the image content transitions from the first scene to the second scene while being displayed on the display, based on the information on the APL value and information on a histogram of the image frames.

The processor may be configured to input the image frames to a neural network model trained to identify objects included in the image frames to acquire information on the objects included in the image frames, and identify whether the image content transitions from the first scene to the second scene while being displayed on the display, based on the information on the objects.

The processor may be configured to adjust the current scaling ratio for the second scene so that a time required for the second current scaling ratio to increase to the first current scaling ratio is greater than or equal to a preset threshold time.

The processor may be configured to adjust the current scaling ratio for the second scene so that a speed of increase from the second current scaling ratio to the first current scaling ratio increases gradually.

The electronic apparatus may further include an illumination sensor, in which the processor may be configured to acquire information on illumination around the electronic apparatus through the illumination sensor, and determine at least one of the second current scaling ratio, the time, and the speed based on the information on the illumination.

The electronic apparatus may further include a communication interface, in which the processor may be configured to acquire information on the illumination around the electronic apparatus from an external device through the communication interface, and determine at least one of the second current scaling ratio, the time, and the speed based on the information on the illumination.

The processor may be configured to, based on the information on the APL value, identify whether the image content transitions from the second scene to the first scene while being displayed on the display, based on the second scene being identified as transitioning to the first scene, adjust the current scaling ratio for the first scene to decrease from a fourth current scaling ratio that is higher than a third current scaling ratio corresponding to the first APL value to the third current scaling ratio, and control the display to display the first image frames included in the first scene based on the adjusted current scaling ratio for the first scene.

In accordance with another aspect of the disclosure, a controlling method of an electronic apparatus includes: displaying image content; acquiring information on an average picture level (APL) value representing average brightness of pixels of image frames included in the image content; identifying based on the information on the APL value, whether a first scene including first image frames, among the image frames, having a first APL value less than a preset threshold value transitions to a second scene including second image frames, among the image frames, the second image frames having a second APL value that is greater than or equal to the preset threshold value; adjusting, based on the first scene being identified as transitioning to the second scene, a current scaling ratio for the second scene while the second scene is displayed on the display, the current scaling ratio being adjusted such that the second scene increases from a second current scaling ratio that is lower than a first current scaling ratio corresponding to the second APL value to the first current scaling ratio; and displaying the second image frames included in the second scene based on the adjusted current scaling ratio for the second scene.

The memory may store information on the current scaling ratio to drive the display according to the APL value, and the information on the current scaling ratio may include information preset to have the current scaling ratio fixed at less than or equal to the preset threshold value.

The identifying of whether the first scene transitions to the second scene may include identifying whether the image content transitions from the first scene to the second scene while being displayed on the display, based on the information on the APL value and information on a histogram of the image frames.

The identifying of whether the first scene transitions to the second scene further may include: inputting the image frames to a neural network model trained to identify objects included in the image frames to acquire information on the objects included in the image frames; and identifying whether the image content transitions from the first scene to the second scene while being displayed on the display, based on the information on the objects.

The adjusting of the current scaling ratio for the second scene may include adjusting the current scaling ratio for the second scene so that a time required for the second current scaling ratio to increase to the first current scaling ratio is greater than or equal to a preset threshold time.

The adjusting of the current scaling ratio for the second scene further may include adjusting the current scaling ratio for the second scene so that a speed of increase from the second current scaling ratio to the first current scaling ratio increases gradually.

The controlling method may further include: acquiring information on illumination around the electronic apparatus; and determining at least one of the second current scaling ratio, the time, and the speed based on the information on the illumination.

The controlling method may further include: acquiring information on illumination around the electronic apparatus from an external device; and determining at least one of the second current scaling ratio, the time, and the speed based on the information on the illumination.

The controlling method may further include: identifying whether the image content transitions from the second scene to the first scene while being displayed on the display, based on the information on the APL value; when the second scene transitions to the first scene, adjusting the current scaling ratio for the first scene to decrease from a fourth current scaling ratio higher than a third current scaling ratio corresponding to the first APL value to the third current scaling ratio; and displaying the first image frames included in the first scene based on the adjusted current scaling ratio for the first scene.

In accordance with still another aspect of the disclosure, there is provided a non-transitory computer-readable recording medium including a program for executing a controlling method of an electronic apparatus, in which the controlling method of an electronic apparatus may include: displaying image content; acquiring information on an average picture level (APL) value representing average brightness of pixels of image frames included in the image content; identifying based on the information on the APL value, whether a first scene including first image frames, among the image frames, having a first APL value less than a preset threshold value transitions to a second scene including second image frames, among the image frames, while the image content is displayed on the display, the second image frames having a second APL value that is greater than or equal to the preset threshold value, based on the information on the APL value; when the first scene transitions to the second scene, adjusting, the first scene being identified as transitioning to the second scene, a current scaling ratio for the second scene while the second scene is displayed on the display, the current scaling ratio being adjusted such that the second scene increases from a second current scaling ratio that is lower than a first current scaling ratio corresponding to the second APL value to the first current scaling ratio; and displaying the second image frames included in the second scene based on the adjusted current scaling ratio for the second scene.

### BRIEF DESCRIPTION OF DRAWINGS

Other aspects, features and advantages of an embodiment according to the present disclosure will become more apparent from the following detailed description taken in conjunction with the accompanying drawings:

FIG. 1 is a block diagram schematically illustrating a configuration of an electronic apparatus according to an embodiment of the present disclosure;

FIG. 2 is a graph exemplarily illustrating the relationship between an APL and a current scaling ratio according to an embodiment of the present disclosure;

FIG. 3 is a diagram for describing an embodiment related to transitioning from a dark scene to a bright scene;

FIG. 4 is a diagram for describing an embodiment related to transitioning from a bright scene to a dark scene;

FIG. 5 is a block diagram illustrating in detail the configuration of the electronic apparatus according to an embodiment of the present disclosure;

FIGS. 6 and 7 are diagrams for describing an electronic apparatus including a display, rather than a self-emissive display, according to an embodiment of the present disclosure;

FIG. 8 is a diagram illustrating an embodiment related to adjusting a current scaling ratio based on information on illumination received from an external device; and

FIG. 9 is a flowchart illustrating a control method of an electronic apparatus according to an embodiment of the present disclosure.

### MODE FOR INVENTION

Since the present embodiments may be variously modified and have several embodiments, specific embodiments of the present disclosure will be illustrated in the drawings and be described in detail in the detailed description. However, it is to be understood that the disclosure are not limited to specific embodiments, but include all modifications, equivalents, and substitutions according to exemplary embodiments of the disclosure. Throughout the accompanying drawings, similar components will be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following embodiments may be modified in several different forms, and the scope and spirit of the disclosure are not limited to the following embodiments. Rather, these embodiments make the disclosure thorough and complete, and are provided to completely transfer the spirit of the disclosure to those skilled in the art.

Terms used in the disclosure are used only to describe specific embodiments rather than limiting the scope of the disclosure. Singular expressions are intended to include plural expressions unless the context clearly indicates otherwise.

In the present disclosure, an expression “have,” “may have,” “include,” “may include,” or the like, indicates existence of a corresponding feature (for example, a numerical value, a function, an operation, a component such as a part, or the like), and does not exclude existence of an additional feature.

In the present disclosure, an expression “A or B,” “at least one of A and/or B,” “one or more of A and/or B,” or the like, may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

Expressions “first,” “second,” “1st” or “2nd” or the like, used in the present disclosure may indicate various components regardless of a sequence and/or importance of the components, will be used only in order to distinguish one component from the other components, and do not limit the corresponding components.

When it is mentioned that any component (for example: a first component) is (operatively or communicatively) coupled with/to or is connected to another component (for example: a second component), it is to be understood that any component is directly coupled to another component or may be coupled to another component through the other component (for example: a third component).

On the other hand, when it is mentioned that any component (for example, a first component) is “directly coupled” or “directly connected” to another component (for example, a second component), it is to be understood that the other component (for example, a third component) is not present between any component and another component.

An expression “configured (or set) to” used in the disclosure may be replaced by an expression “suitable for,” “having the capacity to,” “designed to,” “adapted to,” “made to, or “capable of” depending on a situation. A term “~configured (or set) to” may not necessarily mean “specifically designed to” in hardware.

Instead, an expression “~an apparatus configured to” may mean that the apparatus “is capable of” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory apparatus.

In an embodiment, a “module” or a “unit” may perform at least one function or operation, and be implemented by hardware or software or be implemented by a combination of hardware and software. In addition, a plurality of “modules” or a plurality of “~ers/ors” may be integrated in at least one module and be implemented by at least one processor except for a ‘module’ or an ‘~er/or’ that needs to be implemented by specific hardware.

Meanwhile, various elements and regions in the drawings are schematically illustrated. Therefore, the spirit of the disclosure is not limited by relatively sizes or intervals illustrated in the accompanying drawings.

Hereinafter, embodiments of the disclosure will be described in detail with reference to the accompanying drawings so that those skilled in the art to which the disclosure pertains may easily practice the disclosure.

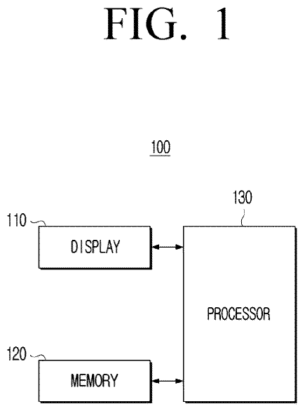

FIG. 1 is a block diagram schematically illustrating a configuration of an electronic apparatus 100 according to an embodiment of the present disclosure.

As illustrated in FIG. 1, the electronic apparatus 100 may include a processor 110, a memory 120, and a processor 130.

The electronic apparatus 100, according to the present disclosure, refers to an apparatus capable of controlling a display of image content. The electronic apparatus 100 may include a display 110 and may be a device (e.g., a TV, a smartphone, and a tablet PC) capable of controlling the display 110 included in the electronic apparatus 100 to display image content. In addition, the electronic apparatus 100 may be a device that may transmit signals/data/information to an external device including the display 110 so that an external device displays the image content (e.g., a set-top box). However, for convenience of description, the following description assumes that the electronic apparatus 100 includes the display 110.

The display 110 may output image data under the control of the processor 130. Specifically, the display 110 may output an image pre-stored in the memory 120 under the control of the processor 130. The display 110 may also display a user interface stored in the memory 120. The display 110 may also be implemented by a flexible display, a transparent display, or the like, in some cases. However, the display 110 according to the present disclosure is not limited to a specific type.

In an embodiment, the display 110 may display image content on the display 110 under the control of the processor 130. Specifically, the display 110 may display image frames included in the image content. Specific operations related to displaying the image content are described in detail in the description of the control operation of the processor 130.

The display 110 according to the present disclosure may be a self-emissive display. Specifically, the display 110 according to the present disclosure may generate images by emitting light on its own, and thus may not include a separate backlight unit (BLU). For example, the display 110 may be a self-emissive display, such as an organic light emitting diode (OLED), a micro light emitting diode (micro LED), or a plasma display panel (PDP).

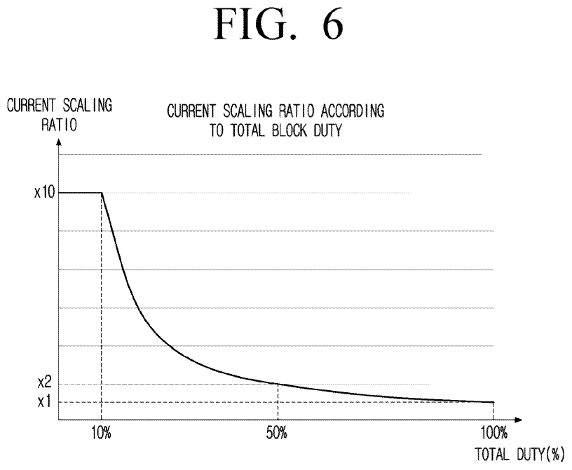

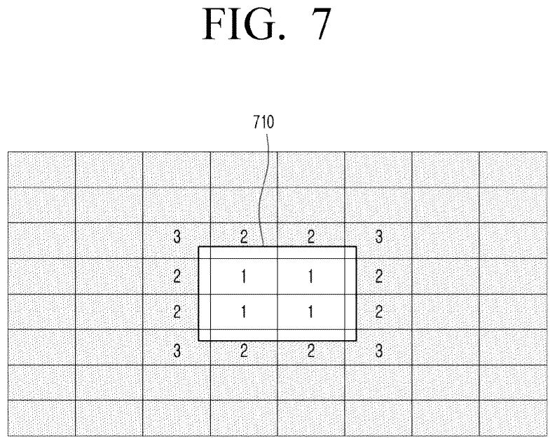

For convenience of description, the following description will assume that the display 110 is implemented as a self-emissive display; however, the present disclosure is not limited thereto. Other types of displays other than self-emissive displays will be described below with reference to FIGS. 6 and 7.

The memory 120 may store at least one instruction regarding the electronic apparatus 100. The memory 120 may store an operating system (O/S) for driving the electronic apparatus 100. In addition, the memory 120 may store various software programs or applications for operating the electronic apparatus 100 according to various embodiments of the present disclosure. The memory 120 may include a semiconductor memory such as a flash memory, or a magnetic storage medium such as a hard disk, or the like.

Specifically, various software modules for operating the electronic apparatus 100 according to various embodiments of the present disclosure may be stored in the memory 120, and the processor 130 may execute various software modules stored in the memory 120 to control the operation of the electronic apparatus 100. That is, the memory 120 is accessed by the processor 130, and readout/recording/correction/deletion/update, and the like, of data in the memory 120 may be performed by the processor 130.

Meanwhile, the term “memory 120” in the present disclosure may be used to include the memory 120, a ROM or RAM within the processor 130, or a memory card (e.g., a micro SD card or memory stick) mounted on the electronic apparatus 100.

In an embodiment, the memory 120 may store image data for image content, information on APL values, information on a current scaling ratio, information on a neural network model, information on a scaling ratio increase method, information on ambient illumination of the electronic apparatus 100, and information on the adjusted current scaling ratio. In addition, various pieces of information necessary within the scope for achieving the object of the present disclosure may be stored in the memory 120, and the information stored in the memory 120 may be updated as received from an external device or input by a user.

The processor 130 controls a general operation of the electronic apparatus 100. Specifically, the processor 130 is connected to the configuration of the electronic apparatus 100, which includes the display 110 and the memory 120, and may control the overall operation of the electronic apparatus 100 by executing at least one instruction stored in the memory 120 as described above.

The processor 130 may be implemented in various schemes. For example, the processor 130 may be implemented by at least one of a processor, an application specific integrated circuit (ASIC), an embedded processor, a microprocessor, a hardware control logic, a hardware finite state machine (FSM), and a digital signal processor (DSP). Meanwhile, in the present disclosure, the term processor 130 may be used as meaning including a central processing unit (CPU), a graphic processing unit (GPU), a main processor unit (MPU), and the like.

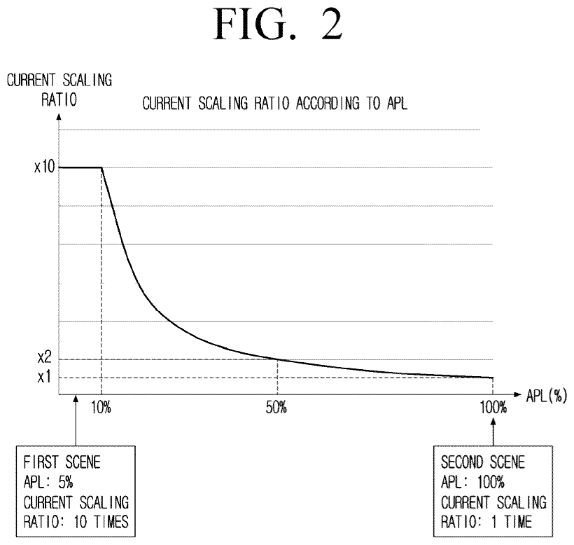

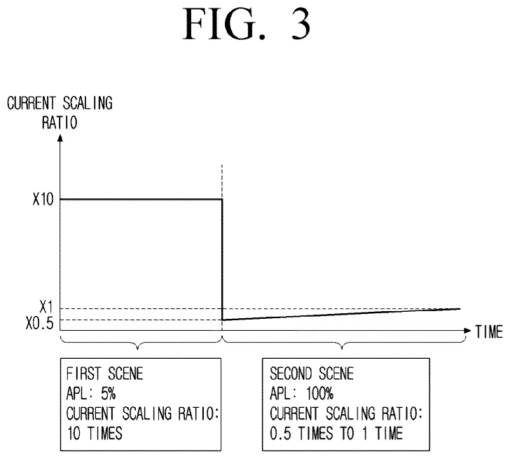

In various embodiments according to the present disclosure, the processor 130 may adjust the current scaling ratio for displaying image content when the brightness of the image content changes abruptly. Various embodiments implemented by the processor 130 will be described below. First, reference will be made to FIGS. 2 and 3.

FIG. 2 is a graph exemplarily illustrating the relationship between the APL and the current scaling ratio according to an embodiment of the present disclosure, and FIG. 3 is a diagram illustrating an embodiment related to a case where a dark scene transitions to a bright scene.

In an embodiment, the processor 130 may adjust the current scaling ratio for displaying the image content when the dark scene transitions (or switches, changes) to the bright scene.

The processor 130 may control the display 110 to display the image content. Specifically, when a user input is received or a preset event occurs, the processor 130 may display the image content based on image data stored in the memory 120.

The processor 130 may acquire information on an average picture level (APL) value representing average brightness of all pixels of each image frame included in the image content, Here, the ‘APL’ refers to a value representing the average brightness of all pixels of each image frame. That is, the APL may represent the average brightness level of the entire display 110 screen. ‘Information on APL values’ may include all APL values acquired for each image frame included in the image content. In addition, the APL value for each image frame may represent an average value for the overall pixel brightness of each image frame.

The processor 130 may analyze the image content while the image content is displayed on the display 110 and acquire the APL value for each image frame included in the image content. For example, the processor 130 may acquire pixel information of image data corresponding to the image content, sum the brightness values of all pixels based on the pixel information, and calculate an average value for the summed brightness values, thereby acquiring the information on the APL value for each image frame.

Meanwhile, the processor 130 may not only analyze the image content in real time while the image content is displayed on the display 110, but may also analyze the image content in advance to acquire the APL value.

When the display 110 is implemented as the self-emissive display, the processor 130 may set the current scaling ratio based on the APL to enhance the maximum brightness when only a portion of the total pixels are turned on and also to maintain stable power consumption.

The “current scaling ratio” may indicate a relative magnitude of current used to drive a pixel at a specific APL. The current scaling ratio may represent a ratio of a current to a reference current. Here, the reference current may be set according to the specifications or design of the display 110.

As illustrated in FIG. 2, the processor 130 may maintain power consumption by reducing the current scaling ratio at a high APL, and may provide sufficient brightness even in the dark scene by increasing the current scaling ratio at a low APL. Referring to the example of FIG. 2, assuming that current scaling ratio is the reference current considering power consumption when the APL is 100%, the current scaling ratio may be set to twice the reference current when the APL is 50%. As in the graph illustrated in FIG. 2, the function representing the current scaling ratio corresponding to the APL may be referred to as a “peak gain curve.”

The information on the current scaling ratio for driving the display 110 based on the APL value may be preset by a developer or user. For example, the distribution of the current scaling ratio corresponding to the distribution of the APL values may be preset or acquired before displaying the image content, and the information on the distribution of the current scaling ratio may be stored in the memory 120.

The information on the current scaling ratio may include preset information for a fixed current scaling ratio at the APL less than or equal to a threshold value. In other words, since the current scaling ratio may not be set to infinity, a maximum value of the current scaling ratio may be set as an upper limit. The maximum value may be determined based on hardware specifications of the display 110 and may represent maximum brightness and power consumption limits that the display 110 may provide. Referring to the example of FIG. 2, when the APL is 10% or less, the current scaling ratio may be fixed to 10 times the reference current.

Based on the information on the APL value, the processor 130 may identify whether a first scene including first image frames having a first APL value less than or equal to a preset threshold value transitions to a second scene including image frames having a second APL value exceeding the threshold value while the image content is displayed on the display 110.

Specifically, the processor 130 may control the display 110 to display the first image frames included in the first scene based on the first APL value, and may identify whether the transition from the first scene to the second scene occurs while the first scene is displayed on the display 110.

The “first scene” refers to a scene including image frames (hereinafter, “the first image frames”) with an APL value (hereinafter, “first APL value”) less than or equal to the preset threshold value. Any such scene may be referred to as the “first scene,” and the “first scene” does not necessarily refer to a specific scene. The first scene has average screen brightness less than or equal to a certain level, and thus may be referred to as a “dark scene.”

As described above, the information on the current scaling ratio may include preset information that maintains the fixed current scaling ratio (i.e., maximum current scaling ratio) less than or equal to the threshold value. In other words, the threshold value may represent the upper limit of the APL value corresponding to the maximum current scaling ratio. Referring to the example in FIG. 2, when the APL value is less than or equal to 10%, the current scaling ratio may be fixed to 10 times the reference current, so the threshold value may be 10%.

The “second scene” refers to a scene including image frames (hereinafter, “the second image frames”) with an APL value (hereinafter, “second APL value”) exceeding the preset threshold value. Any such scene may be referred to as the “second scene,” and the “second scene” does not necessarily refer to a specific scene. The second scene has average screen brightness less than or equal to a certain level, and thus may be referred to as a “brightness scene.”

As described above, the information on the current scaling ratio may include information that sets the current scaling ratio to be non-fixed when the threshold value is exceeded, and in particular, may change non-linearly when the threshold value is exceeded.

Meanwhile, the first and second scenes do not necessarily have to include only image frames with the same APL value, and may also include image frames with similar APL values or with APL values that vary within a specific range. However, for convenience of description, the following description assumes that the image frames within a specific scene have the same APL value.

In the description of FIGS. 2 and 3, as illustrated in FIG. 2, the first scene has an APL value of 5% and a current scaling ratio 10 times the reference current, while the second scene has an APL value of 100% and a current scaling ratio 1 times the reference current. However, this is merely an example.

As described above, the processor 130 may identify whether the image content transitions from the first scene to the second scene while being displayed on the display 110 based on the information on the APL value. However, the processor 130 may also identify whether the scene transition occurs in various other ways.

For example, the processor 130 may identify whether the image content transitions from the first scene to the second scene while being displayed on the display 110 based on the information on the APL value and the information on the histogram of the image frames.

For another example, the processor 130 may input the image frames to the neural network model trained to identify objects included in the image frames, thereby acquiring information on the objects included in the image frames. Furthermore, the processor 130 may identify whether the image content transitions from the first scene to the second scene while being displayed on the display 110 based on the information on the objects.

When the first scene transitions to the second scene, the processor 130 may adjust the current scaling ratio for the second scene so that the second current scaling ratio increases from the second current scaling ratio that is lower than the first current scaling ratio corresponding to the second APL value to the first current scaling ratio while the second scene is displayed on the display 110. The processor 130 may control the display 110 to display the second image frames included in the second scene based on the current scaling ratio adjusted for the second scene.

The amount of light perceived by the user may correspond to the product of the APL and the current scaling ratio. For example, when all pixels emit light at a brightness of 200 nits and when only 10% of the total pixels emit light at a brightness of 2000 nits, the total amount of light output from the display 110 may be considered to be the same.

Accordingly, when the electronic apparatus 100 displays the first image frames included in the first scene based on the first APL value, and then displays the second image frames included in the second scene based on the second APL value, the total amount of light of the display 110 significantly increases, causing the user to experience significant glare.

As illustrated in the example of FIG. 2, the first scene has an APL value of 5% and a current scaling ratio of 10 times the reference current, so the amount of light corresponding to the first scene may be 0.5. The second scene has an APL value of 100% and a current scaling ratio of 1 times the reference current, so the amount of light corresponding to the second scene may be 1. Therefore, when transitioning from the first scene to the second scene, the total amount of light is doubled, thereby causing the user to experience significant glare.

As described above, the information on the current scaling ratio for driving the display 110 may be preset based on the APL value. Accordingly, when the current scaling ratio is not adjusted, the processor 130 may control the display 110 to display the second image frames included in the second scene based on the first current scaling ratio corresponding to the second APL value while the second scene is displayed on the display 110 after the scene change.

However, according to the present disclosure, the processor 130 may adjust the current scaling ratio for the second scene to increase from the second current scaling ratio lower than the first current scaling ratio to the first current scaling ratio, rather than the first current scaling ratio corresponding to the second APL value, while the second scene is displayed on the display 110, and may control the display 110 to display the second image frames included in the second scene based on the adjusted current scaling ratio for the second scene.

Referring to FIG. 3, when the current scaling ratio is not adjusted, the processor 130 may determine the current scaling ratio for the second scene to be 1 time the reference current corresponding to an APL of 100% while the second scene is displayed on the display 110. However, according to the present disclosure, the processor 130 may adjust the current scaling ratio for the second scene to increase from 0.5 times the reference current, which is lower than 1 time the reference current corresponding to the APL of 100%, to 1 time the reference current while the second scene is displayed on the display 110.

Meanwhile, various methods may be used to increase the current scaling ratio from the second current scaling ratio to the first current scaling ratio. Specifically, the time taken to increase the current scaling ratio from the second current scaling ratio to the first current scaling ratio and the type of increase may vary according to the embodiment.

In an embodiment, the processor 130 may adjust the current scaling ratio for the second scene so that the time required to increase from the second current scaling ratio to the first current scaling ratio exceeds a preset threshold time.

In other words, when the time required to increase from the second current scaling ratio to the first current scaling ratio is too short, the amount of light may increase before the user adapts to light, potentially causing glare. On the other hand, when the time required to increase from the second current scaling ratio to the first current scaling ratio is sufficiently long, the amount of light may increase after the user adapts to light, preventing glare. It should be noted that the threshold time may vary depending on developer or user settings.

In an embodiment, the processor 130 may adjust the current scaling ratio for the second scene so that the rate of increase from the second current scaling ratio to the first current scaling ratio gradually increases. In an embodiment, the processor 130 may adjust the current scaling ratio for the second scene so that the rate of increase from the second current scaling ratio to the first current scaling ratio gradually decreases. In other words, although FIG. 3 illustrates a case where the rate of increase from the second current scaling ratio to the first current scaling ratio is constant, i.e., the rate linearly increases from the second current scaling ratio to the first current scaling ratio, the rate of increase from the second current scaling ratio to the first current scaling ratio may also increase nonlinearly.

Specifically, the rate of increase of the current scaling ratio may be constant while increasing from the second current scaling ratio to the first current scaling ratio, but the rate of increase of the current scaling ratio may increase as it increases from the second current scaling ratio to the first current scaling ratio. For example, the rate of increase of the current scaling ratio while increasing from the second current scaling ratio to the first current scaling ratio may sequentially change, such as a first rate (e.g., 0.05 increase per unit time), a second rate (e.g., 0.06 increase per unit time), a third rate (e.g., 0.07 increase per unit time), and an n rate (e.g., 0.1 increase per unit time). Accordingly, the electronic apparatus 100 may minimize user glare due to the sudden change in the amount of light.

According to the embodiments described above with reference to FIGS. 1 to 3, the electronic apparatus 100 may prevent user glare by appropriately adjusting the current scaling ratio even when the brightness of the image content increases suddenly.

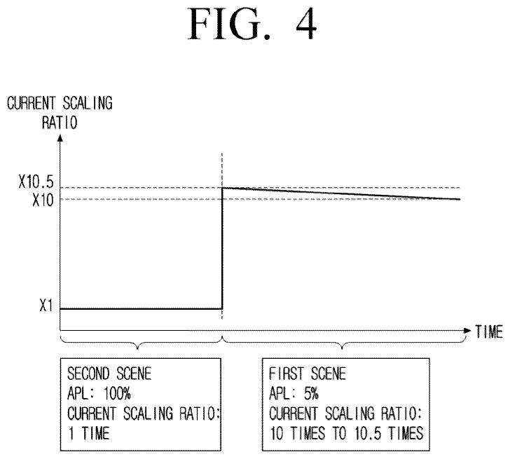

FIG. 4 is a diagram for describing an embodiment related to transitioning from a dark scene to a bright scene.

In an embodiment, the processor 130 may adjust the current scaling ratio for displaying the image content when the scene transitions from the bright scene to the dark scene. Any description overlapping with that of FIGS. 1 to 3 will be omitted below.

The processor 130 may control the display 110 to display the image content, and the processor 130 may acquire the information on the APL value, which represents the average brightness of all pixels in each image frame included in the image content.

Based on the information on the APL value, the processor 130 may identify whether the image content transitions from the second scene to the first scene while being displayed on the display 110. Specifically, the processor 130 may control the display 110 to display the second image frames included in the second scene based on the second APL value, and may identify whether the transition from the second scene to the first scene occurs while the second scene is displayed on the display 110.

As described above, the second scene refers to a ‘bright scene’ including image frames (hereinafter, ‘the second image frames’) having an APL value (hereinafter, ‘second APL value’) exceeding the preset threshold value, and the first scene refers to the ‘dark scene’ including image frames (hereinafter, ‘the first image frames’) having the APL value (hereinafter, ‘first APL value’) less than or equal to the preset threshold value.

In the description of FIG. 4, similar to the descriptions of FIGS. 2 and 3, the first scene will be described as a scene where the APL value is 5% and the current scaling ratio is 10 times the reference current, and the second scene will be described as a scene where the APL value is 100% and the current scaling ratio is 1 times the reference current. However, this is merely an example.

When the second scene transitions to the first scene, the processor 130 may adjust the current scaling ratio for the first scene so that the current scaling ratio decreases from the fourth current scaling ratio, which is higher than the third current scaling ratio corresponding to the first APL value, to the third current scaling ratio. Then, the processor 130 may control the display 110 to display the first image frames included in the first scene based on the adjusted current scaling ratio for the first scene.

When the electronic apparatus 100 displays the second image frames within the second scene based on the second APL value and then displays a first image frame within the first scene based on the first APL value, the total amount of light of the display 110 is significantly reduced, which may cause the user to experience visual discomfort.

Here, the “visual discomfort” is a phenomenon opposite to glare, and is used as a general term to refer to visual discomfort, eye fatigue, etc., experienced by the user when, for example, a scene suddenly transitions from a very bright to a very dark scene.

As described above with the example of FIG. 2, the amount of light corresponding to the first scene may be 0.5, and the amount of light corresponding to the second scene may be 1. Therefore, when the scene transitions from the second scene to the first scene, the total amount of light is reduced by half, which may cause the user to experience significant visual discomfort.

As described above, the information on the current scaling ratio for driving the display 110 may be preset based on the APL value. Accordingly, when the current scaling ratio is not adjusted, the processor 130 may control the display 110 to display the first image frames included in the first scene based on the third current scaling ratio corresponding to the second APL value while the first scene is displayed on the display 110 after the scene change.

However, according to the present disclosure, the processor 130 may adjust the current scaling ratio for the first scene to decrease from the fourth current scaling ratio lower than the third current scaling ratio to the third current scaling ratio, rather than the third current scaling ratio corresponding to the first APL value, while the first scene is displayed on the display 110, and may control the display 110 to display the first image frames included in the first scene based on the adjusted current scaling ratio for the first scene.

Referring to FIG. 3, when the current scaling ratio is not adjusted, the processor 130 may determine the current scaling ratio for the first scene to be 10 times the reference current corresponding to an APL of 5% while the first scene is displayed on the display 110. However, according to the present disclosure, the processor 130 may adjust the current scaling ratio for the first scene to decrease from 10.5 times the reference current, which is higher than 10 times the reference current corresponding to the APL of 5%, to 10 times the reference current while the first scene is displayed on the display 110.

The method of decreasing from the third current scaling ratio to the fourth current scaling ratio may vary. The embodiments relating to the method of increasing from the second current scaling ratio to the first current scaling ratio may similarly be applied to the time and type of increase during the process of decreasing from the third current scaling ratio to the fourth current scaling ratio.

In an embodiment, the processor 130 may adjust the current scaling ratio for the first scene so that the time required to decrease from the third current scaling ratio to the fourth current scaling ratio is greater than or equal to the preset threshold time.

In an embodiment, the processor 130 may adjust the current scaling ratio for the first scene so that the rate of decrease from the third current scaling ratio to the fourth current scaling ratio gradually increases. In an embodiment, the processor 130 may adjust the current scaling ratio for the first scene so that the rate of decrease from the third current scaling ratio to the fourth current scaling ratio gradually decreases.

Meanwhile, the embodiment described above with reference to FIG. 4 may be applied when the fixed current scaling ratio corresponding to the APL value less than or equal to the preset threshold value is set so as not to exceed the hardware specifications of the electronic apparatus 100 and the display 110. In other words, the embodiment described above with reference to FIG. 4 may be applied in the case where 10 times the reference current in the above example does not exceed the hardware specifications of the electronic apparatus 100 and the display 110 and there is a margin of up to 10.5 times the reference current.

In particular, when the display 110 is driven in multiple modes depending on how many times the reference current is set as the maximum current scaling ratio, the processor 130 operates in a first mode, which is the third current scaling ratio with a relatively low maximum current ratio among the multiple modes. When switching from the second scene to the first scene, the processor 130 switches to the second mode, which is the fourth current scaling ratio with a relatively higher maximum current ratio than the first mode, and adjusts the current scaling ratio for the first scene so that it decreases from the fourth current scaling ratio to the third current scaling ratio.

According to the embodiments described above with reference to FIG. 4, the electronic apparatus 100 may prevent the visual comfort of the user by appropriately adjusting the current scaling ratio even when the brightness of the image content decreases suddenly.

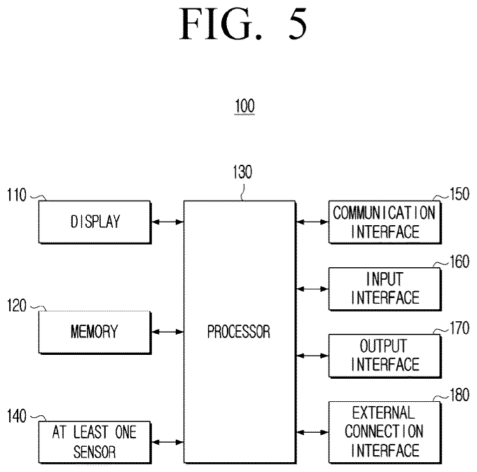

FIG. 5 is a block diagram illustrating in detail a configuration of the electronic apparatus 100 according to an embodiment of the present disclosure.

As illustrated in FIG. 5, the electronic apparatus 100 according to an embodiment of the present disclosure may further include the display 110, the memory 120, and the processor 130, as well as at least one sensor 140, a communication interface 150, an input interface 160, an output interface 170, and an external connection interface 180. However, the configurations illustrated in FIGS. 1 and 5 are merely exemplary, and it is understood that new configurations may be added or some configurations may be omitted in implementing the present disclosure.

At least one sensor 140 may detect various pieces of information inside and outside the electronic apparatus 100. Specifically, at least one sensor 140 may include at least one of a global positioning system (GPS) sensor, a gyro sensor (gyroscope), an acceleration sensor (accelerometer), a Lidar sensor, an inertial measurement unit (IMU), and a motion sensor. Furthermore, at least one sensor 140 may include various types of sensors, such as a temperature sensor, a humidity sensor, an infrared sensor, and a biosensor.

In an embodiment, the electronic apparatus 100 may include an illumination sensor. The illumination sensor refers to a sensor capable of acquiring information on the illumination around the electronic apparatus 100. In this case, the processor 130 may acquire information on the illumination around the electronic apparatus 100 through the illumination sensor and, based on the illumination information, determine at least one of the current scaling ratio, the time required for the current scaling ratio to change (increase or decrease), and the rate at which the current scaling ratio changes (increases or decreases).

The level of glare due to the scene transition may vary depending on the ambient illumination around the electronic apparatus 100. For example, when viewing under a condition in which the illuminance around the electronic apparatus 100 is 100 lux, compared to the case when viewing under a darkroom condition (0 lux), the level of glare caused by the scene transition may be more severe from the user's perspective. In addition, as the ambient illuminance decreases, the brightness should gradually increase in order to reduce glare, whereas as the ambient illuminance increases, even rapid changes in brightness may not cause significant glare. Therefore, the electronic apparatus 100 according to the present disclosure may adjust the current scaling ratio based on the information on the illuminance around the electronic apparatus 100.

As described above, the processor 130 may adjust the current scaling ratio for the second scene so that the time required to increase from the second current scaling ratio to the first current scaling ratio exceeds the preset threshold time. In addition, the processor 130 may adjust the current scaling ratio for the second scene so that the rate of increase from the second current scaling ratio to the first current scaling ratio gradually increases. However, when the information on the illumination around the electronic apparatus 100 is utilized, the processor 130 may further lower the second current scaling ratio itself, further increase the threshold time, and further slow the rate of increase from the second current scaling ratio to the first current scaling ratio, when the illumination around the electronic apparatus 100 is less than or equal to the threshold level.

The communication interface 150 includes a circuit and may communicate with an external device. Specifically, the processor 130 may receive various data or information from an external device connected through the communication interface 150, and may transmit various data or information to the external device.

The communication interface 150 may include at least one of a WiFi module, a Bluetooth module, a wireless communication module, an NFC module, and an ultra-wide band (UWB) module. Specifically, the WiFi module and the Bluetooth module may communicate via WiFi or Bluetooth, respectively. In the case of using the Wi-Fi module or the Bluetooth module, various types of connection information such as an SSID may first be transmitted and received, and after establishing the communication connection by using the connection information, various types of information may be transmitted and received.

In addition, the wireless communication module may perform communications according to various communication standards, such as IEEE, Zigbee, 3rd generation (3G), 3rd generation partnership project (3GPP), long term evolution (LTE), and 5th generation (5G). The NFC chip may perform communications in a near field communication (NFC) manner using a band of 13.56 MHz among various RF-ID frequency bands such as 135 kHz, 13.56 MHz, 433 MHz, 860 to 960 MHz, and 2.45 GHz. In addition, the UWB module may accurately measure a time of arrival (ToA), which is the time it takes for a pulse to reach a target, and an angle of arrival (AoA), which is a pulse arrival angle at a transmitting device, through communication between UWB antennas, thereby enabling precise distance and location recognition within an error range of several tens of centimeters indoors.

In an embodiment, the processor 130 may receive image data corresponding to image content from an external device via the communication interface 150. The processor 130 may receive the information on the APL value, the current scaling ratio, the neural network model information, the scaling ratio increase method information, and the information on the ambient illumination of the electronic apparatus 100 from the external device via the communication interface 150. The processor 130 may control the communication unit to transmit the information on the adjusted current scaling ratio to the external device.

The input interface 160 includes a circuit, and the processor 130 may receive user commands for controlling the operation of the electronic apparatus 100 via the input interface 160. Specifically, the input interface 160 may include components such as a microphone, a camera, and a remote control signal receiving unit. In addition, the input interface 160 is a touch screen, and may be implemented in the form in which it is included in the display 110. In particular, the microphone may receive a voice signal and convert the received voice signal into an electrical signal.

In an embodiment, the processor 130 may receive user input for displaying image content through the input interface 160. The processor 130 may receive user input for changing information that may be changed according to user settings, such as a threshold value or a threshold time, through the input interface 160.

The output interface 170 includes a circuit, and the processor 130 may output various functions that the electronic apparatus 100 may perform through the output interface 170. In addition, the output interface 170 may include at least one of a speaker and an indicator, in addition to the display 110 described above.

The speaker may output audio data under the control of the processor 130. The indicator may be turned on under the control of the processor 130. Specifically, the indicator may be turned on in various colors under the control of the processor 130. For example, the indicator may be implemented in light emitting diodes (LEDs), a liquid crystal display panel (LCD), a vacuum fluorescent display (VFD), etc., but is not limited thereto.

In an embodiment, the processor 130 may control the output unit to provide sound related to the image content or the related information.

The external connection interface 180 may transmit and receive video data and/or audio data in relation to the external device. The external connection interface 180 may be replaced with terms such as the input/output interface, the port interface, or the multimedia interface.

Specifically, the external connection interface 180 may include an input port capable of receiving video data and/or audio data from the external device and an output port capable of transmitting video data and/or audio data to the external device. In particular, when the external connection interface 180 may transmit and receive both video data and audio data, separate input/output ports capable of transmitting and receiving video data and audio data may be implemented. The external connection interface 180 may connect the electronic apparatus 100 and the external device in a wired manner such as a cable, but may also connect the electronic apparatus 100 and the external device wirelessly.

For example, the external connection interface 180 may include a high-definition multimedia interface (HDMI) module, a universal serial bus (USB) module, or the like. The HDMI module is an uncompressed digital video/audio interface standard, and may provide an interface between the electronic apparatus 100 and the external device providing content. The USB module may provide a communication system between the electronic apparatus 100 and the external device providing content using a predefined input/output standard protocol. In addition to the HDMI module and the USB module, the external connection interface 180 may be implemented in various modules for providing input/output of video/audio data between the electronic apparatus 100 and the external device, such as a display port (DP) module, an RGB module, a digital visual interface (DVI) module, and a thunderbolt module.

In particular, in various embodiments according to the present disclosure, the processor 130 may transmit signal/data/information to the external device including the display 110 via the external connection interface 180 so that the external device displays the image content. In addition, the external connection interface 180 may transmit and receive various types of information/data, including control signals, between the electronic apparatus 100 and the external device according to various embodiments according to the present disclosure.

FIGS. 6 and 7 are diagrams illustrating the electronic apparatus 100 including the display 110 that is not the self-emissive display.

The above description assumes that the display 110 is implemented as the self-emissive display, but the display 110 according to the present disclosure may also include a backlight unit.

When the display 110 utilizes the backlight unit (BLU) and local dimming, the processor 130 may adjust the current scaling ratio based on the duty, which represents the ratio of the time the backlight unit is turned on. Here, the duty may be the total sum of duties of all blocks that divides the display 110, and the duty of each block may be determined based on at least one of the APL and histogram of the image input to the corresponding block. For a more detailed description, refer to FIGS. 6 and 7.

FIG. 6 illustrates a peak gain curve when the display 110 utilizes the backlight unit and the local dimming. In the graph, an x-axis represents the duty, and a y-axis represents the current scaling ratio according to the duty.

FIG. 7 illustrates an example of the display 110 that performs the local dimming based on an 8×8 block. As illustrated in FIG. 7, the display 110 may be divided into 8×8, i.e., 64, blocks, each of which may be used to individually brighten or darken a specific area of the display 110 based on the local dimming.

When a box 710 corresponding to a 10% area of the entire screen of the display 110 driven by 8×8 blocks is displayed at a specific brightness and the remaining 90% area is displayed in black (the so-called 10% box pattern), a higher duty cycle may be set as the percentage of the image occupied by each block increases. For example, in FIG. 7, the duty of the block marked with the number 1, the block marked with the number 2, and the block marked with the number 3 may be set high in that order, while the duty of the blocks without a number may be set to 0. Through this operation, the overall duty is set lower than 100%, and as the duty used decreases, the power margin increases, enabling operation in a manner that increases the current scaling ratio of blocks with a non-zero duty.

As described above with reference to FIGS. 6 and 7, even when the display 110 uses the backlight unit and the local dimming, various embodiments described above with reference to FIGS. 1 to 5 may be similarly applied.

Specifically, FIG. 6, which illustrates the peak gain curve when the display 110 uses the backlight unit and the local dimming, may have a form similar to FIG. 2. That is, even in the case of the display 110 that uses the backlight unit and the local dimming, the current scaling ratio may not be set to infinity, and the maximum value of the current scaling ratio may be set to the upper limit.

In addition, when the maximum value of the current scaling ratio is set to the upper limit, if there is a screen transition between the dark scene less than or equal to the current scaling ratio range and the bright scene exceeding the current scaling ratio range, the user may experience glare or visual discomfort. In this case, the electronic apparatus 100 may alleviate the glare or visual discomfort by adjusting the current scaling ratio to vary from a value different from a preset value to the preset value during the scene transition.

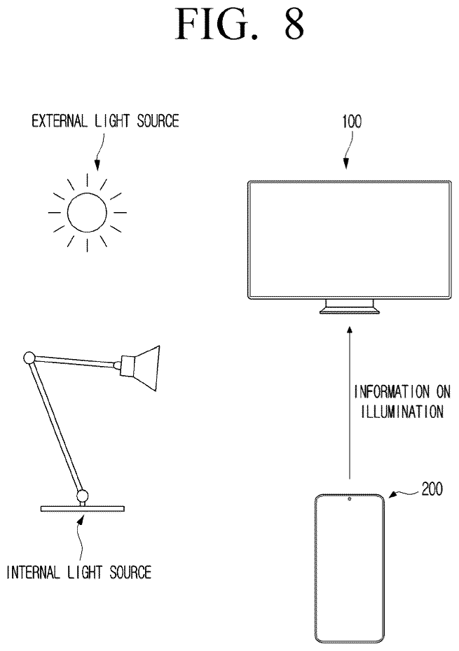

FIG. 8 is a diagram for describing an embodiment related to adjusting the current scaling ratio based on the information on illumination received from the external device.

As described above, the electronic apparatus 100 may acquire the information on the illumination around the electronic apparatus 100 through the illumination sensor included in the electronic apparatus 100 and, based on the illumination information acquired through the illumination sensor, determine at least one of the current scaling ratio, the time required for the current scaling ratio to change, and the speed at which the current scaling ratio changes.

Meanwhile, the electronic apparatus 100 may acquire the information on the illuminance around the electronic apparatus 100 from an external device 200 including an illuminance sensor, and, based on the information on the illuminance acquired from the external device 200, may determine at least one of the current scaling ratio, the time required for the current scaling ratio to change, and the speed at which the current scaling ratio changes.

Specifically, referring to FIG. 8, the electronic apparatus 100 may be disposed in the same space as the external device 200. Here, the external device 200 may include the illumination sensor and communicate with the electronic apparatus 100. For example, the external device 200 may be a smartphone, a tablet PC, a laptop, etc., but is not limited thereto.

When the electronic apparatus 100 and the external device 200 are disposed in the same space, the illumination around the electronic apparatus 100 and the illumination around the external device 200 due to the external light sources outside the space and the internal light sources within the space (e.g., at least one lighting device disposed in the space) may be identical or similar to a threshold level or higher. Therefore, in particular, when the electronic apparatus 100 does not include the illumination sensor and the external device 200 includes the illumination sensor, the electronic apparatus 100 may utilize the illumination sensor included in the external device 200.

In an embodiment, the external device 200 may acquire the information on the illumination around the external device 200 through the illumination sensor. Since the illumination around the electronic apparatus 100 and the illumination around the external device 200 may be the same or similar to each other by the threshold level or higher, the information on the illumination around the external device 200 may be identical to the information on the illumination around the electronic apparatus.

The electronic apparatus 100 may include the communication interface 150, and the processor 130 may acquire the information on the illumination around the electronic apparatus 100 from the external device 200 through the communication interface 150. Furthermore, the processor 130 may determine at least one of the current scaling ratio, the time required for the current scaling ratio to change (increase or decrease), and the speed at which the current scaling ratio changes (increases or decreases) based on the information on the illumination.

As described above, the level of glare due to the scene transition may vary depending on the ambient illumination around the electronic apparatus 100. In addition, the lower the ambient illumination, the more gradual the increase in brightness changes may be to reduce glare. Therefore, the higher the ambient illumination, the faster the brightness changes may be without significant glare.

As described above, the processor 130 may adjust the current scaling ratio for the second scene so that the time required to increase from the second current scaling ratio to the first current scaling ratio exceeds the preset threshold time. In addition, the processor 130 may adjust the current scaling ratio for the second scene so that the rate of increase from the second current scaling ratio to the first current scaling ratio gradually increases. However, when the information on the illumination around the electronic apparatus 100 is utilized, the processor 130 may further lower the second current scaling ratio itself, further increase the threshold time, and further slow the rate of increase from the second current scaling ratio to the first current scaling ratio, when the illumination around the electronic apparatus 100 is less than or equal to the threshold level.

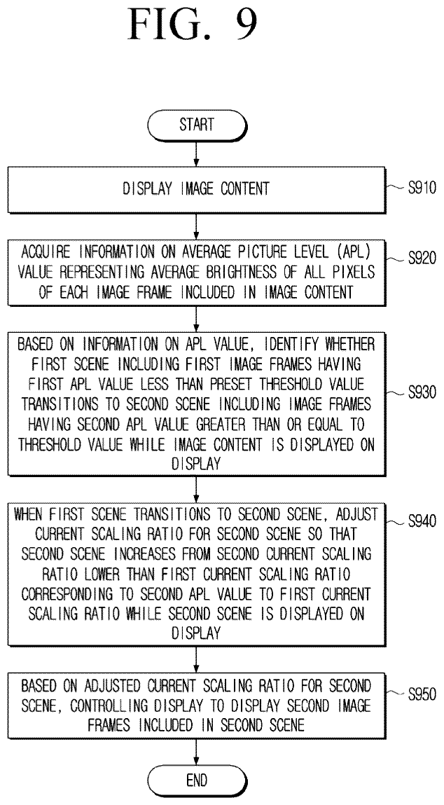

FIG. 9 is a flowchart illustrating a control method of an electronic apparatus 100 according to an embodiment of the present disclosure.

Referring to FIG. 9, the electronic apparatus 100 may display image content (S910). The electronic apparatus 100 may acquire the information on the average picture level (APL) value representing average brightness of all pixels of each image frame included in the image content (S920).

The electronic apparatus 100 may analyze the image content while the image content is displayed on the display 110 (e.g., the display 110 included in the electronic apparatus 100 or the display 110 included in the external device) to acquire the APL value for each image frame included in the image content. For example, the electronic apparatus 100 may acquire the pixel information of the image data corresponding to the image content, sum the brightness values of all pixels based on the pixel information, and calculate the average value for the summed brightness values, thereby acquiring the information on the APL value for each image frame.

Based on the information on the APL value, the electronic apparatus 100 may identify whether a first scene including first image frames having a first APL value less than a preset threshold value transitions to a second scene including image frames having a second APL value greater than or equal to the threshold value while the image content is displayed on the display 110.

Specifically, the electronic apparatus 100 may control the display 110 to display the first image frames included in the first scene based on the first APL value, and may identify whether the transition from the first scene to the second scene occurs while the first scene is displayed on the display 110.

For example, the electronic apparatus 100 may identify whether the image content transitions from the first scene to the second scene while being displayed on the display 110 based on the information on the APL value and the information on the histogram of the image frames.

For another example, the electronic apparatus 100 may input the image frames to the neural network model trained to identify objects included in the image frames, thereby acquiring information on the objects included in the image frames. Furthermore, the electronic apparatus 100 may identify whether the image content transitions from the first scene to the second scene while being displayed on the display 110 based on the information on the objects.

When the first scene transitions to the second scene, the electronic apparatus 100 may adjust the current scaling ratio for the second scene so that the second current scaling ratio increases from the second current scaling ratio that is lower than the first current scaling ratio corresponding to the second APL value to the first current scaling ratio while the second scene is displayed on the display 110 (S940). Then, the electronic apparatus 100 may control the display 110 to display the second image frames included in the second scene based on the adjusted current scaling ratio for the second scene (S950).

The electronic apparatus 100 may adjust the current scaling ratio for the second scene to increase from the second current scaling ratio lower than the first current scaling ratio to the first current scaling ratio, rather than the first current scaling ratio corresponding to the second APL value, while the second scene is displayed on the display 110, and may control the display 110 to display the second image frames included in the second scene based on the adjusted current scaling ratio for the second scene.

In an embodiment, the electronic apparatus 100 may adjust the current scaling ratio for the second scene so that the time required to increase from the second current scaling ratio to the first current scaling ratio exceeds a preset threshold time.

In an embodiment, the electronic apparatus 100 may adjust the current scaling ratio for the second scene so that the rate of increase from the second current scaling ratio to the first current scaling ratio gradually increases. In an embodiment, the electronic apparatus 100 may adjust the current scaling ratio for the second scene so that the rate of increase from the second current scaling ratio to the first current scaling ratio gradually decreases.

Meanwhile, the control method of an electronic apparatus 100 according to the above-described embodiment may be implemented as a program and provided to the electronic apparatus 100. In particular, a program including the control method of an electronic apparatus 100 may be provided by being stored in a non-transitory computer readable medium.

Specifically, in a non-transitory computer-readable recording medium including a program for executing a controlling method of an electronic apparatus 100, the control method of an electronic apparatus 100 may include displaying image content, acquiring information on an average picture level (APL) value representing average brightness of all pixels of each image frame included in the image content, based on the information on the APL value, identifying whether a first scene including first image frames having a first APL value less than a preset threshold value transitions to a second scene including image frames having a second APL value greater than or equal to the threshold value while the image content is displayed on the display 110, when the first scene transitions to the second scene, adjusting a current scaling ratio for the second scene so that the second scene increases from a second current scaling ratio lower than a first current scaling ratio corresponding to the second APL value to the first current scaling ratio while the second scene is displayed on the display 110, and based on the adjusted current scaling ratio for the second scene, controlling the display to display the second image frames included in the second scene.

In the above description, the control method of an electronic apparatus 100 and the computer-readable recording medium including the program for executing the control method of an electronic apparatus 100 have been briefly described, but this is only for omitting redundant description, and it goes without saying that various embodiments of the electronic apparatus 100 is also applicable to the computer-readable recording medium including the control method of an electronic apparatus 100 and the program for executing the control method of an electronic apparatus 100.

The artificial intelligence-related functions according to the present disclosure are operated through the processor 130 and memory 120 of the electronic apparatus 100.

The processor 130 may be composed of one or more processors 130. In this case, the one or more processors 130 may include at least one of a central processing unit (CPU), a graphic processing unit (GPU), and a neural processing unit (NPU), but are not limited to the examples of the processor 130 described above.

The CPU is a general-purpose processor 130 capable of performing not only general operations but also artificial intelligence operations, and may efficiently execute complex programs through a multi-layer cache structure. The CPU is advantageous in a serial processing method that enables organic linking of previous and subsequent calculation results through sequential calculations. Except the case where specifically referred to as the CPU described above, the general-purpose processor 130 is not limited to the examples described above.

The GPU is the processor 130 for large-scale computations, such as floating-point operations used in graphics processing, and integrates a large number of cores to perform large-scale computations in parallel. In particular, the GPU may be advantageous over CPUs for parallel processing methods, such as convolution operations. Furthermore, the GPU may be used as coprocessors 130 to supplement the functions of the CPU. Except the case where specifically referred to as the GPU described above, the processor 130 for large-scale computations is not limited to the examples described above.

The NPU is the processor 130 specialized for artificial intelligence computations using the artificial neural network, and may implement each layer of the artificial neural network in hardware (e.g., silicon). In this case, since the NPU is designed to be specialized according to the specifications required by the manufacturer, the NPU has less flexibility compared to the CPU or GPU, but may efficiently process the artificial intelligence operations required by the manufacturer. Meanwhile, the NPU is the processor 130 specialized for the artificial intelligence operations, and may be implemented in various forms, such as a tensor processing unit (TPU), an intelligence processing unit (IPU), and a vision processing unit (VPU). Except where specifically referred to as the NPU described above, the AI processor 130 is not limited to the examples described above.

In addition, the one or more processors 130 may be implemented as a system on chip (SoC). In this case, the SoC may further include the memory 120, and the network interface, such as a bus for the data communication between the processor 130 and the memory 120, in addition to the one or more processors 130.

When the system on chip (SoC) included in the electronic apparatus 100 includes the plurality of processors 130, the electronic apparatus 100 may use some of the processors 130 to perform the AI-related operations (e.g., operations related to AI model learning or inference). For example, the electronic apparatus 100 may use at least one of the GPU, NPU, VPU, TPU, or hardware accelerator specialized for AI operations, such as a convolution operation or a matrix multiplication operation, among the plurality of processors 130. However, this is merely an example, and it is understood that the AI-related operations may be processed using the CPU or other general-purpose processor 130.

In addition, the electronic apparatus 100 may use a plurality of cores (e.g., dual cores, quad cores, etc.) included in the single processor 130 to perform the operations related to the AI-related functions. In particular, the electronic apparatus 100 may perform the artificial intelligence operations such as the convolution operations and the matrix multiplication operations in parallel using the multi-core included in the processor 130.

One or more processors 130 control to process the input data according to the predefined operation rule or the AI model stored in the memory 120. The predefined operation rule or the AI model is characterized by being made through training.

Here, being created through learning means that a predefined motion rule or an artificial intelligence model of a desired characteristic is created by applying a learning algorithm to a plurality of training data. Such learning may be made in the device itself in which the AI according to the present disclosure is performed, or may be made through a separate server/system.

The AI model may include a plurality of neural network layers. At least one layer has at least one weight value, and an operation of the layers is performed based on an operation result of a previous layer and at least one defined operation. Examples of neural networks may include models such as a convolutional neural network (CNN), a deep neural network (DNN), a recurrent neural network (RNN), a restricted Boltzmann machine (RBM), a deep belief network (DBN), a bidirectional recurrent deep neural network (BRDNN), deep Q-networks, and a transformer, and in the present disclosure, unless otherwise specified, the neural networks are not limited to the foregoing examples.

The learning algorithm is a method of training a target device (e.g., a robot) using a plurality of pieces of training data so that the predetermined target device may make decisions or predictions on its own. Examples of the learning algorithms include supervised learning, unsupervised learning, semi-supervised learning, or reinforcement learning, but in the present disclosure, unless otherwise specified, the learning algorithm is not limited to the foregoing examples.

The machine-readable storage medium may be provided in a form of a non-transitory storage medium. Here, the ‘non-transitory storage medium’ means that the storage medium is a tangible device, and does not include a signal (for example, electromagnetic waves), and the term does not distinguish between the case where data is stored semi-permanently on a storage medium and the case where data is temporarily stored thereon. For example, the “non-transitory storage medium” may include a buffer in which data is temporarily stored.

According to an embodiment, the methods according to the diverse exemplary embodiments disclosed in the present document may be included and provided in a computer program product. The computer program product may be traded as a product between a seller and a purchaser. The computer program product may be distributed in the form of a machine-readable storage medium (for example, compact disc read only memory (CD-ROM)), or may be distributed (for example, download or upload) through an application store (for example, Play Store™) or may be directly distributed (for example, download or upload) between two user devices (for example, smart phones) online. In a case of the online distribution, at least some of the computer program products (for example, downloadable app) may be at least temporarily stored in a machine-readable storage medium such as the memory 120 of a server of a manufacturer, a server of an application store, or a relay server or be temporarily created.

Each of components (for example, modules or programs) according to various embodiments of the present disclosure as described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration.

Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Meanwhile, terms “~er/or” or “module” used in the present disclosure may include units configured by hardware, software, or firmware, and may be used compatibly with terms such as, for example, logics, logic blocks, components, circuits, or the like. The “unit” or “module” may be an integrally configured component or a minimum unit performing one or more functions or a part thereof. For example, the module may be configured by an application-specific integrated circuit (ASIC).

Various embodiments of the present disclosure may be implemented by software including instructions stored in a machine-readable storage medium (for example, a computer-readable storage medium). A machine may be a device that invokes the stored instruction from the storage medium and may be operated depending on the invoked instruction, and may include the electronic apparatus (for example, the electronic apparatus 100) according to the disclosed embodiments.

In a case where a command is executed by the processor, the processor may directly perform a function corresponding to the command or other components may perform the function corresponding to the command under a control of the processor. The command may include codes created or executed by a compiler or an interpreter.

Although exemplary embodiments of the present disclosure have been illustrated and described hereinabove, the present disclosure is not limited to the abovementioned specific exemplary embodiments, but may be variously modified by those skilled in the art to which the present disclosure pertains without departing from the gist of the present disclosure as disclosed in the accompanying claims. These modifications should also be understood to fall within the scope and spirit of the present disclosure.

1. An electronic apparatus, comprising:
a display;
a memory configured to store at least one instruction; and
a processor, configured to execute the at least one instruction, to:
control the display to display image content,
acquire information on an average picture level (APL) value representing average brightness of pixels of image frames included in the image content,
identify based on the information on the APL value, whether a first scene including first image frames, among the image frames, having a first APL value that is less than a preset threshold value transitions to a second scene including second image frames, among the image frames, while the image content is displayed on the display, the second image frames having a second APL value that is greater than or equal to the preset threshold value,
adjust, based on the first scene being identified as transitioning to the second scene, a current scaling ratio for the second scene while the second scene is displayed on the display, the current scaling ratio being adjusted such that the second scene increases from a second current scaling ratio that is lower than a first current scaling ratio corresponding to the second APL value to the first current scaling ratio, and
control the display to display the second image frames included in the second scene based on the adjusted current scaling ratio for the second scene.

2. The electronic apparatus as claimed in claim 1, wherein the memory stores information on the current scaling ratio to drive the display according to the APL value, and
the information on the current scaling ratio includes information preset to have the current scaling ratio fixed at less than or equal to the preset threshold value.

3. The electronic apparatus as claimed in claim 1, wherein the processor is configured to identify whether the image content transitions from the first scene to the second scene while being displayed on the display, based on the information on the APL value and information on a histogram of the image frames.

4. The electronic apparatus as claimed in claim 1, wherein the processor is configured to input the image frames to a neural network model trained to identify objects included in the image frames to acquire information on the objects included in the image frames, and
identify whether the image content transitions from the first scene to the second scene while being displayed on the display, based on the information on the objects.

5. The electronic apparatus as claimed in claim 1, wherein the processor is configured to adjust the current scaling ratio for the second scene so that a time required for the second current scaling ratio to increase to the first current scaling ratio is greater than or equal to a preset threshold time.

6. The electronic apparatus as claimed in claim 5, wherein the processor is configured to adjust the current scaling ratio for the second scene so that a speed of increase from the second current scaling ratio to the first current scaling ratio increases gradually.

7. The electronic apparatus as claimed in claim 6, further comprising:
an illumination sensor,
wherein the processor is configured to acquire information on illumination around the electronic apparatus through the illumination sensor, and
determine at least one of the second current scaling ratio, the time, and the speed based on the information on the illumination.

8. The electronic apparatus as claimed in claim 7, further comprising:
a communication interface,
wherein the processor is configured to acquire information on the illumination around the electronic apparatus from an external device through the communication interface, and
determine at least one of the second current scaling ratio, the time, and the speed based on the information on the illumination.

9. The electronic apparatus as claimed in claim 1, wherein
the processor is configured to, based on the information on the APL value, identify whether the image content transitions from the second scene to the first scene while being displayed on the display,
based on the second scene being identified as transitioning to the first scene, adjust the current scaling ratio for the first scene to decrease from a fourth current scaling ratio higher that is than a third current scaling ratio corresponding to the first APL value to the third current scaling ratio, and
control the display to display the first image frames included in the first scene based on the adjusted current scaling ratio for the first scene.

10. A controlling method of an electronic apparatus, comprising:
displaying image content on a display;
acquiring information on an average picture level (APL) value representing average brightness of pixels of image frames included in the image content;
identifying based on the information on the APL value, whether a first scene including first image frames, among the image frames, having a first APL value less than a preset threshold value transitions to a second scene including second image frames, among the image frames, while the image content is displayed on the display, the second image frames having a second APL value greater that is than or equal to the preset threshold value; and
adjusting, based on the first scene being identified as transitioning to the second scene, a current scaling ratio for the second scene while the second scene is displayed on the display, the current scaling ratio being adjusted such that the second scene increases from a second current scaling ratio that is lower than a first current scaling ratio corresponding to the second APL value to the first current scaling ratio; and
displaying the second image frames included in the second scene based on the adjusted current scaling ratio for the second scene.

11. The controlling method as claimed in claim 10, wherein a memory stores information on the current scaling ratio to drive the display according to the APL value, and
the information on the current scaling ratio includes information preset to have the current scaling ratio fixed at less than or equal to the preset threshold value.

12. The controlling method as claimed in claim 10, wherein the identifying of whether the first scene transitions to the second scene includes identifying whether the image content transitions from the first scene to the second scene while being displayed on the display, based on the information on the APL value and information on a histogram of the image frames.

13. The controlling method as claimed in claim 10, wherein the identifying of whether the first scene transitions to the second scene further includes:
inputting the image frames to a neural network model trained to identify objects included in the image frames to acquire information on the objects included in the image frames; and
identifying whether the image content transitions from the first scene to the second scene while being displayed on the display, based on the information on the objects.

14. The controlling method as claimed in claim 10, wherein the adjusting of the current scaling ratio for the second scene includes adjusting the current scaling ratio for the second scene so that a time required for the second current scaling ratio to increase to the first current scaling ratio is greater than or equal to a preset threshold time.

15. The controlling method as claimed in claim 14, wherein the adjusting of the current scaling ratio for the second scene further includes adjusting the current scaling ratio for the second scene so that a speed of increase from the second current scaling ratio to the first current scaling ratio increases gradually.
